(19) United States
(12) Patent Application Publication
(10) Pub. No.: US 2013/0029140 A1
(43) Pub. Date: Jan. 31, 2013

(54) OUTER PACKAGING MATERIAL FOR BATTERY OR CAPACITOR, AND PROCESS FOR PRODUCING SAME

(71) Applicants: Naoki Takao, Marugame-shi (JP); Yasunori Senoo, Marugame-shi (JP); Masanao Orihara, Marugame-shi (JP); Masamichi Oyama, Marugame-shi (JP); Yukio Kouzai, Marugame-shi (JP)

(72) Inventors: Naoki Takao, Marugame-shi (JP); Yasunori Senoo, Marugame-shi (JP); Masanao Orihara, Marugame-shi (JP); Masamichi Oyama, Marugame-shi (JP); Yukio Kouzai, Marugame-shi (JP)

(73) Assignee: OKURA INDUSTRIAL CO., LTD., Marugame-shi, Kagawa (JP)

(21) Appl. No.: 13/641,579

(22) PCT Filed: Apr. 7, 2011
(86) PCT No.: PCT/JP2011/058815

§ 371 Date: Oct. 16, 2012

(30) Foreign Application Priority Data
Apr. 23, 2010 (JP) 2010-100035

(51) Int. Cl. H01M 2/02; B29C 65/70; H01G 2/10

(52) U.S. Cl. 428/336; 428/461; 428/458; 156/244.11

(57) ABSTRACT

An outer packaging material for a battery or capacitor includes, a base layer, a barrier layer, an adhesive layer and a sealant layer which are sequentially laminated, has high adhesion between the barrier layer and the adhesive layer and is a good moisture barrier. The adhesive layer includes a maleic anhydride-modified polypropylene, wherein α and β, defined below, satisfy all the following conditions: α≧0.09; β≧10; and αβ≦2.0; wherein a represents a ratio (A₁₇₉₀/A₈₄₀) of a peak height (A₁₇₉₀) at 1790 cm⁻¹ to a peak height (A₈₄₀) at 840 cm⁻¹ in infrared absorption spectrum of the maleic anhydride-modified polypropylene and β represents a thickness of the adhesive layer in μm.

### TECHNICAL FIELD

The present invention relates to an outer packaging material for a battery, such as a lithium ion battery or lithium polymer battery, or a capacitor and, more specifically, to a film-type outer packaging material for a thin battery or capacitor, and to a process for producing same.

### BACKGROUND ART

As an outer packaging material for thin batteries and capacitors, which are recently being developed in a remarkable manner, an outer packaging material having a base layer, a barrier layer, an adhesive layer and a sealant layer which are laminated in this order is known. For example, an outer packaging material disclosed in Patent Document 1 is composed of a base layer of a heat-resistant biaxially-oriented film, a barrier layer of an aluminum foil, a sealant layer of a polypropylene (which is hereinafter referred to as “PP”), and has an adhesive layer of a maleic anhydride-modified polypropylene (which is hereinafter referred to as “MAH-modified PP”) between the barrier layer and the sealant layer. The outer packaging material disclosed in Patent Document 1 is provided with electrolyte-resisting properties and solvent resistance by the MAH-modified PP. However, the adhesion between the barrier layer and the MAH-modified PP layer is not necessarily sufficient, because the MAH-modified PP is as thin as 1 μm as seen in Example 1.

An outer packaging material disclosed in Patent Document 2 has a base layer of a stretched nylon film, a barrier layer of an aluminum foil, an adhesive layer of an MAH-modified PP, and a sealant layer of an unstretched PP. The adhesion strength between the barrier layer and the adhesive layer is higher than that in the outer packaging material of Patent Document 1, because the adhesive layer of the outer packaging material has a thickness of approximately 15 to 20 μm. However, the MAH-modified PP of the adhesive layer has a low degree of modification and the adhesion strength needs further improvement.

The present inventors have examined the influence of change in the degree of modification on the outer packaging material by varying the degree of modification of the MAH-modified PP used for the adhesive layer and found that as the degree of modification is increased, the adhesion between the barrier layer and the adhesive layer improves but, at the same time, the moisture barrier property decreases. It is inferred that this is because, as the degree of modification of the MAH-modified PP for the adhesive layer is increased, the proportion of polar groups in the adhesive layer increases, allowing easy penetration of moisture through end faces of the adhesive layer.

The moisture barrier property is one of important properties which an outer packaging material for a battery or capacitor is required to satisfy. When an outer packaging material has a low moisture barrier property, moisture penetrates into the battery or capacitor and reacts with the electrolytic solution therein to form hydrofluoric acid. The generation of hydrofluoric acid may increase the pressure in the battery to cause separation of sealed portions. In addition, when the hydrofluoric acid reaches the barrier layer through the sealant layer or adhesive layer, a surface of the barrier layer is corroded, which leads to a deterioration in the performance of the battery or capacitor.

### PRIOR ART DOCUMENT

### Patent Document

Patent Document 1: JP-A-2001-102011

Patent Document 2: JP-A-2005-216707

### DISCLOSURE OF THE INVENTION

### Problems to be Solved by the Invention

It is, therefore, an object of the present invention to provide an outer packaging material for a battery or capacitor (which is hereinafter referred to as “outer packaging material”) which includes a base layer, a barrier layer, an adhesive layer and a sealant layer that are sequentially laminated and which has high adhesion between the barrier layer and the adhesive layer and a high moisture barrier property.

### Means for Solving the Problems

In accordance with the present invention, there is provided, as means for solving the above problems, an outer packaging material for a battery or capacitor, including a base layer, a barrier layer, an adhesive layer and a sealant layer which are sequentially laminated, the barrier layer including a metal foil, the adhesive layer including a maleic anhydride-modified polypropylene, the sealant layer including a polypropylene,

wherein α and β, defined below, satisfy all the following inequalities (1) to (3);

α≧0.09 (1)

β≧10 (2)

αβ≦2.0 (3)

wherein α represents a ratio (A₁₇₉₀/A₈₄₀) of a peak height (A₁₇₉₀) at 1790 cm⁻¹ to a peak height (A₈₄₀) at 840 cm⁻¹ in infrared absorption spectrum of the maleic anhydride-modified polypropylene forming the adhesive layer and β represents a thickness of the adhesive layer in μm.

Also provided is the outer packaging material for a battery or capacitor, wherein the base layer includes a biaxially-oriented polyester film.

Also provided is the outer packaging material for a battery or capacitor, wherein the base layer includes a biaxially-oriented nylon film.

Also provided is the outer packaging material for a battery or capacitor, wherein the base layer includes a two-layer film obtained by laminating a biaxially-oriented polyester film and a biaxially-oriented nylon film.

Also provided is the outer packaging material for a battery or capacitor, wherein the barrier layer includes an aluminum foil.

Also provided is a process for the production of the outer packaging material for a battery or capacitor, including coextruding the maleic anhydride-modified polypropylene and polypropylene into a film to obtain a two-layer film having the adhesive layer of the malaic anhydride-modified polypropylene and the sealant layer of the polypropylene, and bonding the barrier layer including a metal foil to the adhesive layer side of the two-layer film.

### EFFECT OF THE INVENTION

The outer packaging material according to the present invention in which α≧0.09 and β≧10 wherein α represents the ratio (A₁₇₉₀/A₈₄₀) of the height of peak at 1790 cm⁻¹ (A₁₇₉₀) to the height of peak at 840 cm⁻¹ (A₈₄₀) in infrared absorption spectrum of the MAH-modified PP forming the adhesive layer and β represents the thickness of the adhesive layer in μm, has high adhesion between the barrier layer and the adhesive layer. In addition, the outer packaging material according to the present invention, in which αβ≦2.0, has a high moisture barrier property.

### BRIEF DESCRIPTION OF THE DRAWINGS

FIG. 1 is a schematic cress-sectional view of one embodiment of an outer packaging material according to the present invention.

FIG. 2 shows graphs of equations α=0.09, β=10 and αβ=2.0.

### EMBODIMENTS OF THE INVENTION

While description is hereinafter made of an outer packaging material according to the present invention with reference to an embodiment thereof, the present invention is not limited to the embodiment.

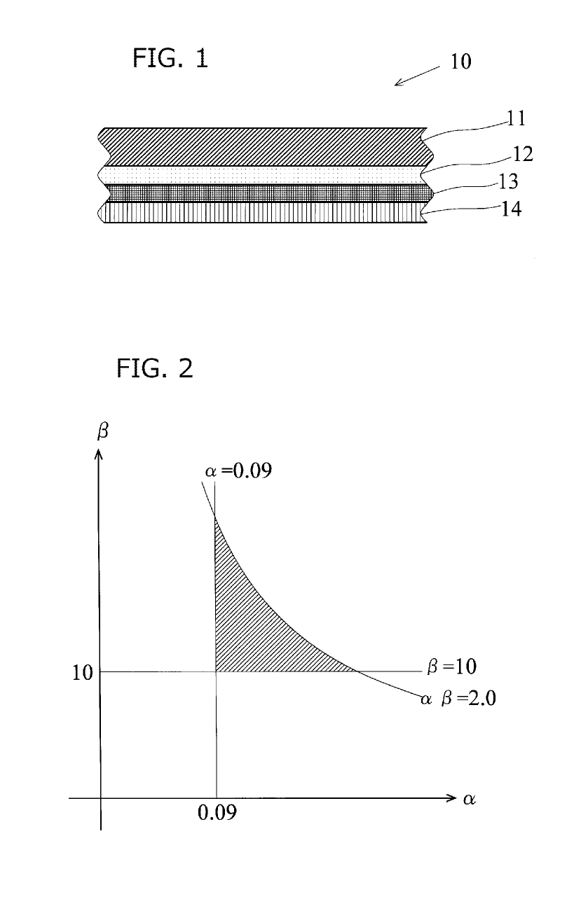

FIG. 1 is a schematic cross-sectional view showing an outer packaging material according to the present invention. The outer packaging material has a base layer 11, a barrier layer 12, an adhesive layer 13, and a sealant layer 14 from one surface thereof to the other.

The base layer 11 a layer which, when the outer packaging material according to the present invention is used as an outer packaging material of a battery or capacitor, forms the exterior of the battery or capacitors and is required to have a certain degree of strength and insulating capacity. As the base layer 11, a biaxially-oriented polyester film or biaxially-oriented nylon film may be used. A biaxially-oriented polyester film may be produced by forming a resin, such as polyethylene terephthalate, polybutylene terephthaIate polyethylene naphthalate or a copolymerized polyester e.g., an ethylene terephthalate/ethylene isophthalate copolymer or butylene terephthalatefbutylene isophthalate copolymer, into a film by a well-known film-formation method, such as a T-die extrusion molding method or inflation extrusion molding method, and then stretching the film in two directions, longitudinally and transversely. A biaxially-oriented nylon film may be obtained by forming a resins such as nylon 6, nylon 6,6, a copolymer of nylon 6,6 and nylon 6, nylon 6,10 polymetaxylylene adipamide (MXD6), into a film by a well-known method as in the above method and then biaxially stretching the film.

A two-layer film obtained by laminating a biaxially-oriented polyester film and a biaxially-oriented nylon film has a good balance between strength and stretch and is therefore especially suitable as the base layer 11. In this case, however, the outermost layer of the base layer is preferably formed of the biaxially-oriented polyester film with the biaxially-oriented nylon film facing the barrier layer because a nylon resin easily degrades when in contact with an electrolytic solution. The two-layer base layer 11 composed of a biaxially-oriented polyester film and a biaxially-oriented nylon film may be obtained by producing the films separately by a method as described above and then bonding the films to each other with an adhesive, or by producing a two-layer film by a co-extrusion molding method and biaxially stretching the laminate film.

The barrier layer 12 is a layer for preventing water vapor from penetrating from outside into the battery. As the barrier layer 12, a foil of a metal, such as aluminum, nickel or stainless, may be used, and the use of an aluminum foil is preferred from economical point of view. It is known that the addition of a small amount of iron to an aluminum foil improves its ductility and reduces generation of pinholes when it is bent. Thus, when an aluminum foil is used as the barrier layer 12, the aluminum foil preferably contains 0.3 to 9.0% by weight, preferably 0.7 to 2.0% by weight, of iron. In addition, because the flexibility, toughness and hardness of an aluminum foil produced by cold rolling vary depending on the annealing (what is called softening treatment) conditions, the use of a partially or fully annealed aluminum foil which tends to be soft, rather than a hardening-treated product which has not been subjected to annealing is preferred in the present invention. The barrier layer 12 preferably has a thickness of 15 μm or greater, especially preferably 20 μm or greater, from the viewpoint of moisture barrier property and resistance to pinholes. When the resistance to impact and piercing is regarded as particularly important, the barrier layer 12 preferably has a thickness of approximately 80 to 120 μm.

The surfaces of a metal foil (especially, an aluminum foil) are Liable to be corroded by acidic substances. Thus, the barrier layer 12 has been preferably subjected to an acid-resistant treatment. When the barrier layer 12 has been subjected to an acid-resistant treatment, the barrier layer 12 is prevented from being corroded even when hydrofluoric acid is generated in the battery and reaches the barrier layer 12. In addition, an acid-resistant treatment is also effective in improving the adhesion between the barrier layer 12 and the adhesive layer 13. While a chromate treatment is a common acid-resistant treatment method, a non-chromate treatment, such as boehmite treatment, parkerizing treatment or triazine thiol treatment, may be used. The acid-resistant treatment may be performed only on the adhesive layer 13 side surface of the barrier layer 12 or on both surfaces of the barrier layer 12.

The adhesive layer 13 is next described. The adhesive layer 13 of the outer packaging material according to the present invention is composed of an MAH-modified PP. Specifically, the adhesive layer 13 of the outer packaging material according to the present invention is composed of an MAH-modified PP having a higher degree of modification than a MAH-modified PP used conventionally in an outer packaging material for a battery or capacitor. More specifically, when a ratio (A₁₇₉₀/A₈₄₀) of the peak height (A₁₇₉₀) at 1790 cm⁻¹ derived from MAH to the peak height (A₈₄₀) at 840 cm⁻¹ derived from polypropylene in infrared absorption spectrum (absorbance), which is an index that indicates the degree of modification of MAH-modified PP, is represented by α, α is approximately 0.008 to 0.071 for an MAH-modified PP used conventionally for an outer packaging material for battery or capacitor. On the other hand, in the outer packaging material according to the present invention, α of the MAN-modified PP for use in the adhesive layer thereof is 0.09 or more, preferably α is 0.10 or more. An adhesive layer of an MAH-modified PP with α<0.09 does not have sufficient adhesion to the barrier layer. It should be noted that the position of infrared absorption spectrum may have a margin of error of approximately ±1 cm⁻¹ depending on the conditions during measurement.

The present inventors have also found that even when an MAH-modified PP with α≧0.09 is used as the adhesive layer the adhesive layer cannot have sufficient adhesion when it is too thin, and that the adhesive layer should have a thickness β of 10 μm or greater, preferably 15 μm or greater. Incidentally, it is when the thickness of the adhesive layer is up to approximately 30 μm that the adhesion of the adhesive layer varies depending on its thickness. The thickness of the adhesive layer has little influence on its adhesion when the thickness exceeds 30 μm.

To increase the adhesion between the barrier layer 12 and the adhesive layer 13, the greater α is, the better, and β is preferably increased up to approximately 30 μm. However, as both α and β are greater, moisture tends to penetrate through end faces of the adhesive layer. Thus, the present inventors conducted studies for an outer packaging material suitable for the application of a battery or capacitor in terms of moisture barrier property, and, consequently, found that a good moisture barrier property can be obtained when αβ 2.0 or less, especially, when αβ is less than 1.7. FIG. 2 shows graphs of equations α=0.09, β=10 and αβ=2.0. The area where α≧0.09, β≧10 and αβ≦2.0 are all satisfied is as indicated by a hatched pattern. An outer packaging material with α<0.09 or β<10 has low adhesion and an outer packaging material with αβ>2 has a poor moisture barrier property.

The sealant layer 14 is next described. The sealant layer 14 is composed of a PP which has good adhesion to the MAH-modified PP and high heat-sealability. Examples of resins for forming the PP include polypropylene resins, such as homopolymers of propylene propylene-ethylene copolymers, and propylene-ethylene-butene copolymers. The thickness of the sealant layer 14 is not specifically limited but a thickness of 10 to 130 μm is appropriate. The sealant layer 14 may not exhibit good sealability when the thickness is 10 μm or smaller, and does not show much improvement in sealing strength when the thickness is greater than 130 μm.

A process for the production of an outer packaging material 10 according to the present invention is next described. Generally, there are two production methods as described below. A first production method includes bonding the base Layer 11 to one side of the barrier layer 12 and then bonding the sealant Layer 14 to the other side of the barrier layer 12 via the adhesive layer 13. A second production method includes bonding the sealant Layer 14 to one side of the barrier Layer 12 via the adhesive layer 13 and then bonding the base Layer 11 to the other side of the barrier layer 12.

One common way to bond the sealant layer 14 to the barrier layer 12 via the adhesive layer 13 is to use what is called an extrusion lamination method, in other words, to prepare the barrier layer 12 and the sealant layer 14, both in the form of a film, in advance and melt-extrude the MAH-modified PP to form the adhesive layer 13 between the barrier layer 12 and the sealant layer 14. However because the MAH-modified PP of the present invention has high adhesion to the barrier layer 12, it is possible to adopt a method including first coextruding the MAH-modified PP and PP into a film to produce a laminate of the adhesive layer 13 and the sealant layer 14, and then thermocompression bonding the barrier layer 12 to the adhesive layer 13 side of the laminate.

In other words the outer packaging material 10 may be produced by forming the MAH-modified PP and PP into a film by a co-extrusion method to form a two-layer film having the adhesive layer 13 and the sealant layer 14, bonding the barrier layer 12 to the adhesive layer 13 side of the two-layer film, and bonding the base layer 11 to the barrier layer. Alternatively, the outer packaging material 10 may be produced by forming the MAH-modified PP and PP into a film by a co-extrusion method to form a two-layer film having the adhesive layer 13 and the sealant layer 14 producing a laminate by bonding the barrier layer 12 and the base layer 11 to each other, and bonding the adhesive layer 13 of the two-layer film having the adhesive layer 13 and the sealant layer 14 to the barrier layer 12 of the laminate having the barrier layer 12 and the base layer 11.

### EXAMPLE

An adhesion test and a moisture barrier property test were conducted to confirm the effects of the present invention. In the adhesion test and moisture barrier properly test, the MAH-modified PP1 to MAR-modified PP8 as shown in Table 1 were used.

TABLE 1

| | Melting | | | | α (A₁₇₉₀/ |
|---|---|---|---|---|---|
| | point | MI | A₁₇₉₀ | A₈₄₀ | A₈₄₀) |
| MAH-modified PP1 | 122 | 3.6 | 0.088 | 0.789 | 0.112 |
| MAH-modified PP2 | 134 | 3.2 | 0.013 | 0.185 | 0.070 |
| MAH-modified PP3 | 168 | 5.0 | 0.053 | 0.887 | 0.060 |
| MAH-modified PP4 | 170 | 7.8 | 0.026 | 0.486 | 0.053 |
| MAH-modified PP5 | 144 | 3.0 | 0.038 | 0.761 | 0.050 |
| MAH-modified PP6 | 125 | 1.6 | 0.010 | 0.270 | 0.037 |
| MAH-modified PP7 | 143 | 3.6 | 0.004 | 0.350 | 0.011 |
| MAH-modified PP8 | 144 | 20 | 0.004 | 0.402 | 0.010 |

### [Adhesion Test]

To measure the adhesion between a barrier layer and adhesive layers, barrier layers of an aluminum foil (40 μm) with a chromate-treated surface and two-layer test films 1 to 12, each having an adhesive layer and a sealant layer, were prepared. The test films 1 to 12 were produced by a T-die co-extrusion method using the MAH-modified PP1 to MAH-modified PP8 shown in Table 1 as the adhesive layers and a polypropylene as the sealant layers. At this time, the thickness of the adhesive layers was varied as shown in Table 2, and the sealant layers had a thickness of 30 μm.

Then, sealing was conducted with a sealer heated to 190° C. at a sealing pressure of 1 MPa for three seconds to seal a barrier layer and each two-layer film having an adhesive layer and a sealant layer such that the chromate-treated surface of the barrier layer was in contact with the adhesive layer. After that, the adhesion strength at which the sealed portion was separated was measured with an autograph, and the obtained value was defined as the adhesion between the barrier layer and the adhesive layer. The results are summarized in Table 2.

TABLE 2

| | | | | Adhesion |
|---|---|---|---|---|
| | Adhesive layer | α | β (μm) | strength (N/mm) |
| Test film 1 | MAH-modified PP1 | 0.112 | 5 | 4.8 |
| Test film 2 | MAH-modified PP1 | 0.112 | 10 | 9.7 |
| Test film 3 | MAH-modified PP1 | 0.112 | 20 | 10.2 |
| Test film 4 | MAH-modified PP2 | 0.070 | 10 | 5.0 |
| Test film 5 | MAH-modified PP2 | 0.070 | 20 | 5.5 |
| Test film 6 | MAH-modified PP2 | 0.070 | 30 | 5.6 |
| Test film 7 | MAH-modified PP3 | 0.060 | 10 | 4.8 |
| Test film 8 | MAH-modified PP4 | 0.053 | 10 | 4.0 |
| Test film 9 | MAH-modified PP5 | 0.050 | 10 | 3.8 |
| Test film 10 | MAH-modified PP6 | 0.037 | 10 | 3.5 |
| Test film 11 | MAH-modified PP7 | 0.011 | 10 | 2.1 |
| Test film 12 | MAH-modified PP8 | 0.010 | 10 | 1.9 |

An outer packaging material is superior as the adhesion between the barrier layer and the adhesive layer is higher. When an outer packaging material is used as an outer packaging material of a battery or capacitor the adhesion is preferably 9.0 N/mm or higher. It is therefore obvious from Table 2 that α≧0.09 and β≧10 are required to obtain high adhesion strength.

### [Moisture Barrier Property Test]

To measure the moisture barrier property of adhesive layers test films 13 to 17 were produced by bonding barrier layers of an aluminum foil (40 μm) with a chromate-treated surface to the test films 2 to 6. The bonding was carried out such that the chromate treated surface of the aluminum foils was in contact with the adhesive layer of the test films 2 to 6 by applying a mechanical pressure of 50 kg/cm² for 10 seconds at a temperature of 220° C. with a middle-sized pressing machine.

Then, the obtained three-layer films, each having a barrier layer, an adhesive layer and a sealant layer which were sequentially laminated, were cut into test pieces with a size of 35 mm×50 mm. Two identical test pieces were prepared and stacked such that their sealant layers were in contact with each other, and the peripheries of the laminate were sealed at a temperature of 190° C. and a pressure 1 MPa to produce a package. At this time, the package was filled with 1 ml of a filling fluid (propylene carbonate).

The obtained packages were allowed to stand still in an environment at a room temperature of 80° C. and a humidity of 90% for one week. Then, the filling fluid was taken out and the water content contained in the propylene carbonate was measured by Karl Fischer titration. The results are summarized in Table 3.

TABLE 3

| | Adhesive layer/ | | | | Water |
|---|---|---|---|---|---|
| | sealant layer | α | β | αβ | content |
| Test film 13 | Test film 2 | 0.112 | 10 | 1.12 | 38 |
| | (MAH-modified PP1/PP) | | | | |
| Test film 14 | Test film 3 | 0.112 | 20 | 2.24 | 78 |
| | (MAH-modified PP1/PP) | | | | |
| Test film 15 | Test film 4 | 0.070 | 10 | 0.7 | 30 |
| | (MAH-modified PP2/PP) | | | | |
| Test film 16 | Test film 5 | 0.070 | 20 | 1.4 | 55 |
| | (MAH-modified PP2/PP) | | | | |
| Test film 17 | Test film 6 | 0.070 | 30 | 2.1 | 71 |
| | (MAH-modified PP2/PP) | | | | |

An outer packaging material used for the application of a battery or capacitor must have a high moisture barrier property. Specifically, the water content as measured in the above test is preferably 60 ppm or less. The above test results indicate that the water content falls within the target range when αβ≦2. The test films 15 and 16 using the test films 4 and 5 respectively, have a high moisture barrier properly but, according to the previous adhesion test results, have insufficient adhesion to the barrier layer.

### Example 1

First, a biaxially-oriented polyethylene terephthalate film and a biaxially-oriented nylon film were bonded to each other by a dry laminate method to produce a base layer (PET/NY). Next, an aluminum foil with a chromate-treated surface was prepared as a barrier layer. The base layer and the barrier layer were laminated (PET/NY/AL) with an adhesive such that the nonchromate-treated surface of the aluminum foil faced the biaxially-oriented nylon film of the base layer. Then, a two-layer film composed of the MAH-modified PP1 (α=0.112) shown in Table 1 and a PP was produced by a T-die co-extrusion method to obtain a two-layer film having an adhesive layer of the MAH-modified PP1 and a sealant layer of a PP. Finally, the barrier layer (AL) of the base layer/barrier Layer laminate film (PET/NY/AL) and the adhesive layer/sealant layer laminate film (MAH-modified PP1/PP) were laminated such that the barrier layer (AL) was in contact with the adhesive layer (MAH-modified PP1) to produce an outer packaging material (PET/NY/AL/MAH-modified PP1/PP). The thicknesses of the layers were as follows; PET: 9 μm, NY: 15 μm, AL: 40 μm, MAH-modified PP1: 17 μm, and PP: 33 μm.

The obtained film was formed into a tray shape by a deep-drawing method, and a battery body was inserted into the tray to produce a lithium ion battery. Even after being used for a long period of time, the lithium ion battery did not have any separation between the barrier layer and the adhesive layer and showed no signs of moisture penetration.

### INDUSTRIAL APPLICABILITY

The present invention can be used as an outer packaging material for a battery, such as a lithium ion battery or lithium polymer, or a capacitor.

### DESCRIPTION OF REFERENCE NUMERALS

10: outer packaging material
11: base layer
12: barrier layer
13: adhesive layer
14: sealant layer

1. An outer packaging material for a battery or capacitor, comprising a base layer, a barrier layer, an adhesive layer and a sealant layer which are sequentially laminated,
the barrier layer including a metal foil, the adhesive layer including a maleic anhydride-modified polypropylene, the sealant layer including a polypropylene,
wherein α and β defined below, satisfy all the following inequalities (1) to (3);
α≧0.09 (1)
β≧10 (2)
αβ≦2.0 (3)
wherein α represents a ratio (A₁₇₉₀/A₈₄₀) of a peak height (A₁₇₉₀) at 1790 cm⁻¹ to a peak height (A₈₄₀) at 840 cm⁻¹ in infrared absorption spectrum of the maleic anhydride-modified polypropylene forming the adhesive layer and β represents a thickness of the adhesive layer in μm.

2. The outer packaging material for a battery or capacitor according to claim 1, wherein the base layer includes a biaxially-oriented polyester film.

3. The outer packaging material for a battery or capacitor according to claim 1, wherein the base layer includes a biaxially-oriented nylon film.

4. The outer packaging material for a battery or capacitor according to claim 1, wherein the base layer includes a two-layer film obtained by laminating a biaxially-oriented polyester film and a biaxially-oriented nylon film.

5. A process for producing an outer packaging material for a battery or capacitor,
the outer packaging material comprising a base layer, a barrier layers an adhesive layer and a sealant layer which are sequentially laminated,
the barrier layer including a metal 1011% the adhesive layer including a maleic anhydride-modified polypropylene, the sealant layer including a polypropylene,
wherein α and β defined below satisfy all the following inequalities (1) to (3);
α≧0.09 (1)
β≧10 (2)
αβ≦2.0 (3)
wherein α represents a ratio (A₁₇₉₀/A₈₄₀) of a peak height (A₁₇₉₀) at 1790 cm⁻¹ to a peak height (A₈₄₀) at 840 cm⁻¹ in infrared absorption spectrum of the maleic anhydride-modified polypropylene forming the adhesive layer and β represents a thickness of the adhesive layer in μm,
said process being characterized by comprising forming the maleic anhydride-modified polypropylene and the polypropylene into a film by a co-extrusion method to obtain a two-layer film having the adhesive layer and the sealant layer, then bonding the barrier layer to the adhesive layer side of the two-layer film, and bonding the base layer to the barrier layer.

6. The production process according to claim 5, wherein the base layer includes a biaxially-oriented polyester film.

7. The production process according to claim 5, wherein the base layer includes a biaxially-oriented nylon film.

8. The production process according to claim 5, wherein the base layer includes a two-layer film obtained by laminating a biaxially-oriented polyester film and a biaxially-oriented nylon film.

9. The production process according to claim 8,
the process being for the production of an outer packaging material for a battery or capacitor, the outer packaging material comprising a base layer, a barrier layer, an adhesive layer and a sealant layer which are sequentially laminated,
the barrier layer including a metal foil, the adhesive layer including a maleic anhydride-modified polypropylene, the sealant layer including a polypropylene, and
wherein α and β defined below satisfy all the following inequalities (1) to (3); wherein α represents a ratio (A₁₇₉₀/A₈₄₀) of a peak height (A₁₇₉₀) at 1790 cm⁻¹ to a peak height (A₈₄₀) at 840 cm⁻¹ in infrared absorption spectrum of the maleic anhydride-modified polypropylene forming the adhesive layer and β represents a thickness of the adhesive layer in μm,
said process being characterized by comprising forming the maleic anhydride-modified polypropylene and the polypropylene into a film by a co-extrusion molding process to obtain a two-Layer film having the adhesive Layer and the sealant layer, bonding the barrier layer to the base layer to produce a laminate, and then bonding the adhesive layer of the two-layer film having the adhesive layer and the sealant layer to the barrier layer of the laminate having the barrier layer and the base layer.

10. The production process according to claim 9, wherein the base layer includes a biaxially-oriented polyester film.

11. The production process according to claim 9, wherein the base layer includes a biaxially-oriented nylon film.

12. The production process according to claim 9, wherein the base layer includes a two-layer film obtained by laminating a biaxially-oriented polyester film and a biaxially-oriented nylon film.
